(19) United States
(12) Patent Application Publication
(10) Pub. No.: US 2006/0070360 A1
(43) Pub. Date: Apr. 6, 2006

(54) Filter service system and method

(75) Inventors: Cheryl L. Sellers, Peoria, IL (US); Christie S. Ragle, Havana, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 11/067,008

(22) Filed: Feb. 28, 2005

Related U.S. Application Data
(63) Continuation-in-part of application No. 10/958,226, filed on Oct. 5, 2004.

(51) Int. Cl. B01D 46/04

(52) U.S. Cl. 55/303

(57) ABSTRACT

A system for removing matter from a filtering device includes a gas pressurization assembly. An element of the gas pressurization assembly is removably connectable to the filtering device and has a surface defining a plurality of orifices. The plurality of orifices is positioned on the surface to direct a flow beyond at least one blocking apparatus of the filtering device. The system further includes a matter collection assembly removably connectable to the filtering device.

### PRIORITY DATA

This application is a continuation in-part of U.S. application Ser. No. 10/958,226, filed Oct. 5, 2004.

### TECHNICAL FIELD

The present disclosure relates generally to a filter service system, and more particularly to a system for removing matter from a filter.

### BACKGROUND

Engines, including diesel engines, gasoline engines, natural gas engines, and other engines known in the art may exhaust a complex mixture of pollutants. The pollutants may be composed of gaseous and solid material, including particulate matter, nitrogen oxides (“NOx”), and sulfur compounds.

Due to heightened environmental concerns, engine exhaust emission standards have become increasingly stringent over the years. The amount of pollutants emitted from an engine may be regulated depending on the type, size, and/or class of engine. One method that has been implemented by engine manufacturers to comply with the regulation of particulate matter, NOx, and sulfur compounds exhausted to the environment has been to remove these pollutants from the exhaust flow of an engine with filters. However, extended use and repeated regeneration of such filters may cause the pollutants to build up in the components of the filters, thereby causing filter functionality and engine performance to decrease.

One method of removing built-up pollutants from a filter may be to remove the clogged filter from the work machine to which it is connected and direct a flow of gas through the filter in a direction that is opposite the direction of normal flow. The filter may be large, heavy, and difficult to disconnect, making it cumbersome, time consuming, and dangerous to remove the filter from the engine of the work machine for servicing.

Another method of removing matter from a filter may be to divert an exhaust flow from the clogged filter to a separate filter, without disconnecting either filter from the engine. While the exhaust flow is diverted, air may be directed through the clogged filter in a direction opposite the normal flow. Since such matter removal systems include a second filter, however, they may be larger and more costly than single filter systems. In addition, since these systems are not disconnected or removed from the engine during cleaning, the user may not be able to manipulate the reverse flow of air within the housing of the clogged filter. Thus, matter that is located out of the direct path of the reverse flow may be difficult to remove from such systems. Furthermore, such systems may not be capable of applying a negative pressure to the clogged filter to assist in removing the matter.

U.S. Pat. No. 5,566,545 (“the '545 patent”) teaches a system for removing particulate matter from an engine filter. In particular, the '545 patent discloses a filter connected to an engine exhaust line, a valve structure within the exhaust line, and an air feeder. When air is supplied to the filter in a reverse flow direction, the air may remove captured particulates from the filter.

Although the '545 patent may teach the removal of matter from a filter using a reversed flow, the system described therein requires the use of a second filter during the reverse flow condition, thereby increasing the overall cost and size of the system. Moreover, the system is not capable of supplying a negative pressure to the filter to assist in the filter cleaning process.

The present disclosure is directed to overcoming one or more of the problems set forth above.

### SUMMARY OF THE INVENTION

In one embodiment of the present disclosure, a system for removing matter from a filtering device includes a gas pressurization assembly. An element of the gas pressurization assembly is removably connectable to the filtering device and has a surface defining a plurality of orifices. The plurality of orifices is positioned on the surface to direct a flow beyond at least one blocking apparatus of the filtering device. The system further includes a matter collection assembly removably connectable to the filtering device.

In another embodiment of the present disclosure, a system for removing matter from a filtering device includes a gas pressurization assembly. An element of the gas pressurization assembly includes a surface defining a plurality of orifices. The plurality of orifices are positioned on the surface to direct a flow across substantially an entire cross-section of a filter media of the filtering device when the gas pressurization assembly is connected to the filtering device. The system further includes a matter collection assembly removably connectable to the filtering device.

In yet another embodiment of the present disclosure, a method of removing matter from a filtering device includes connecting a gas pressurization assembly to the filtering device and connecting a matter collection assembly to the filtering device. The method further includes directing a flow of compressed gas across substantially an entire cross-section of a filter media of the filtering device.

### BRIEF DESCRIPTION OF THE DRAWINGS

FIG. 1 is a diagrammatic illustration of a service system connected to a filter according to an exemplary embodiment of the present disclosure.

FIG. 2 is a cross-sectional view of a filter according to an exemplary embodiment of the present disclosure.

FIG. 3 is a front view of a flow distribution device according to an exemplary embodiment of the present disclosure.

FIG. 4 is a diagrammatic illustration of a filter in an operating flow condition according to an exemplary embodiment of the present disclosure.

FIG. 5 is a diagrammatic illustration of a service system connected to a filter in a reversed flow arrangement according to an exemplary embodiment of the present disclosure.

FIG. 6 is a diagrammatic illustration of a service system connected to a filter according to another exemplary embodiment of the present disclosure.

### DETAILED DESCRIPTION

Exemplary embodiments of the present disclosure are illustrated in the accompanying drawings. Wherever possible, the same reference numbers will be used throughout the drawings to refer to the same or like parts.

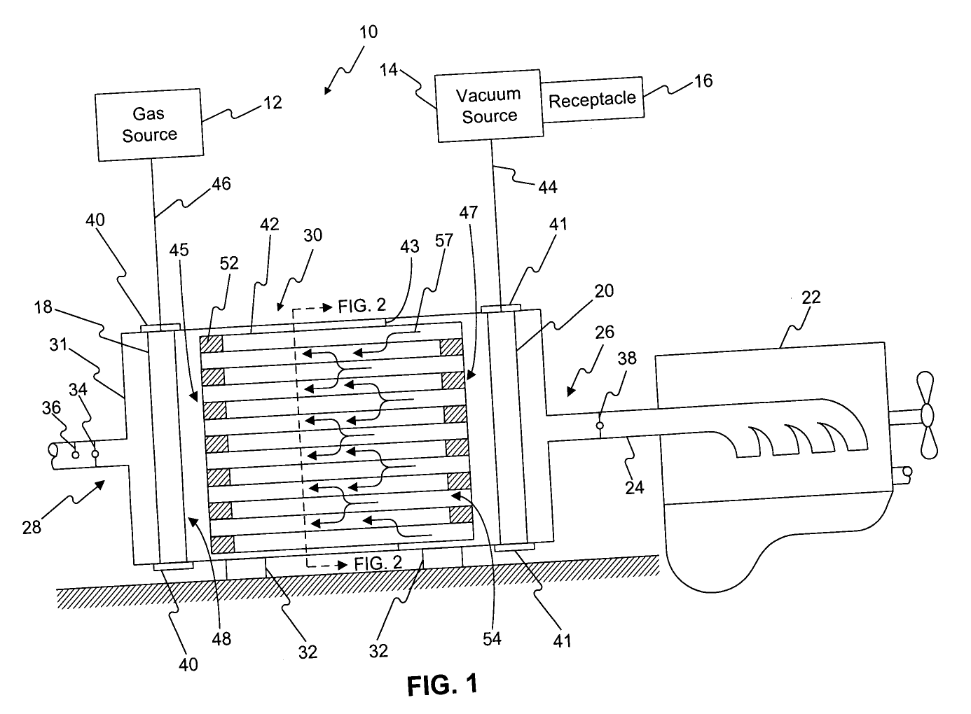

FIG. 1 illustrates an exemplary embodiment of a service system 10 attached to a filter 30. The service system 10 may include a gas source 12, a gas line 46, and a flow distribution device 18. The service system 10 may further include a vacuum source 14, a vacuum line 44, a flow receiving device 20, and a receptacle 16. The service system 10 may be operatively attached to the filter 30 for service and may be removed from the filter 30 when service is complete. As such, a user may operatively attach and remove the service system 10 without removing the filter 30 from the work machine, vehicle, or other device to which the filter 30 is attached. As used herein, the term “work machine” may include on-road vehicles, off-road vehicles, and stationary machines, such as, for example, generators and/or other exhaust producing devices.

In some embodiments of the present disclosure, the filter 30 may be connected to an internal combustion engine 22, such as, for example, a diesel engine. The engine 22 may include an exhaust line 24 connecting an exhaust flow of the engine 22 with an inlet 26 of the filter 30. The engine 22 may also include a turbo (not shown) connected to the exhaust line 24. In such an embodiment, the inlet 26 of the filter 30 may be connected to an outlet of the turbo.

An inlet valve 38 may be disposed between the exhaust line 24 of the engine 22 and the inlet 26 of the filter 30. The inlet valve 38 may be configured to allow an exhaust flow of the engine 22 to pass into the filter 30. Alternatively, in some situations, the inlet valve 38 may block communication between the engine 22 and the filter 30. Such a configuration may be advantageous during, for example, servicing of the filter 30. In an embodiment of the present disclosure, while the filter 30 is being serviced, the inlet valve 38 may be closed to prohibit captured material from flowing back to the engine 22. In such an embodiment, the engine 22 may be turned off during the servicing and, thus, may not produce an exhaust flow. The inlet valve 38 may be controlled and/or actuated by any means known in the art, such as, for example, a solenoid or pneumatics. Alternatively, the inlet valve 38 may be manually controlled.

In some embodiments, one or more work machine diagnostic devices 36 may be disposed proximate an outlet 28 of the filter 30. The work machine diagnostic devices 36 may be, for example, part of the work machine or other device to which the filter 30 is connected and may be external to the filter 30. Alternatively, the work machine diagnostic devices 36 may be internal to the filter 30. Work machine diagnostic devices 36 may be any sensing devices known in the art, such as, for example, flow meters, emission meters, pressure transducers, radio devices, or other sensors. Such work machine diagnostic devices 36 may sense, for example, an increase in the levels of soot, NOx, or other pollutants leaving the filter 30. The work machine diagnostic devices 36 may send pollutant-level information to a controller or other device (not shown) and may assist in, for example, triggering filter regeneration and/or filter servicing.

Filter 30 may further include an outlet valve 34 disposed proximate an outlet 28 of the filter 30. Outlet valve 34 and inlet valve 38 may be the same type of valve or may be different types of valves, depending on the requirements of the application. The valves 38, 34 may be, for example, poppet valves, butterfly valves, or any other type of controllable flow valves known in the art. For example, the valves 38, 34 may be controlled to allow any range of exhaust flow to pass from the engine 22 to the filter 30 and out of the filter 30. The valves 38, 34 may be positioned to completely restrict a flow, such as, for example, during servicing of the filter 30. The valves 38, 34 may also be positioned to allow an exhaust flow of the engine 22 to pass unrestricted during normal operation. The valves 38, 34 may be connected to the filter 30 by any conventional means known in the art.

The filter 30 may be any type of filter known in the art, such as, for example, a foam cordierite, sintered metal, or silicon carbide type filter. As illustrated in FIG. 1, the filter 30 may include filter media 42. The filter media 42 may include any material useful in removing pollutants from an exhaust flow. In an embodiment of the present disclosure, the filter media 42 may contain catalyst materials capable of collecting, for example, soot, NOx, sulfur compounds, particulate matter, and/or other pollutants known in the art. Such catalyst materials may include, for example, alumina, platinum, rhodium, barium, cerium, and/or alkali metals, alkaline-earth metals, rare-earth metals, or combinations thereof. The filter media 42 may be situated horizontally (as shown in FIG. 1), vertically, radially, or helically. The filter media 42 may also be situated in a honeycomb, mesh, or any other configuration so as to maximize the surface area available for the filtering of pollutants.

In an exemplary embodiment, the filter media 42 may define a plurality of filter passages 54. The filter passages 54 may be arranged in any configuration known in the art. For example, the filter passages 54 may be substantially parallel channels extending in an axial direction. The filter passages 54 may be, for example, flat, cylindrical, square tube-shaped, or any other shape known in the art. The filter passages 54 may have desired porosities and/or other characteristics based on the catalyst materials of the filter media 42, and may be configured to allow, for example, gases to pass between adjacent filter passages 54 while substantially restricting the passage of, for example, pollutants. For example, exhaust gases and/or air may pass between adjacent filter passages 54 while the passage of soot, NOx, sulfur compounds, particulate matter, and/or other pollutants therebetween may be substantially restricted. The flow of such gases between adjacent filter passages 54 in a normal flow direction is illustrated by the arrows 57 in FIG. 1.

In an exemplary embodiment, a plurality of filter passages 54 may be substantially blocked or closed at an end of the filter 30 such that gas may not enter the filter passage 54 at the blocked end. The filter 30 may include a plurality of blocking apparatuses 52 configured to assist in blocking a flow of gas. In an exemplary embodiment of the present disclosure, the blocking apparatuses 52 may be plugs or other conventional blocking devices and may be formed of any metal, ceramic, or other material known in the art.

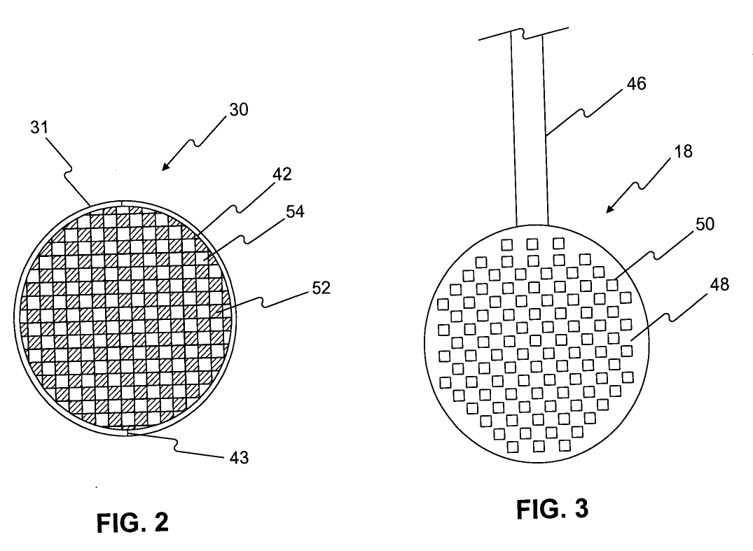

It is understood that the filter passages 54 and the blocking apparatuses 52 may be arranged in any way so as to maximize the filtering of, for example, exhaust gas. As shown in FIGS. 1 and 2, in an exemplary embodiment, the filter passages 54 and the blocking apparatuses 52 may be configured in a substantially checkerboard-like pattern within the filter media 42. In such a configuration, adjacent filter passages 54 may be alternatively blocked by blocking apparatuses 52 at each end of the filter media 42. This exemplary arrangement may assist in forcing exhaust gas to pass between adjacent filter passages 54 and capturing particulate matter and/or other pollutants carried by the gas along, for example, the walls of the filter passages 54.

Referring again to FIG. 1, the filter 30 includes a filter housing 31 and may be secured by any means known in the art. The filter 30 may include, for example, filter brackets 32 connected to the filter housing 31. Filter brackets 32 may be made of metal, plastic, rubber, or any other material known in the art to facilitate connecting a filter to a structure associated with the engine 22. For example, filter brackets 32 may secure the filter 30 to a work machine and may dampen the filter 30 from vibration, jarring, or sudden movements of the work machine to which the filter 30 is attached. It is understood that the filter media 42 may be secured within the filter housing 31 by any means known in the art. In an exemplary embodiment, the filter 30 may include one or more filter media supports 43 configured to secure the filter media 42 to the filter housing 31.

As shown in FIG. 1, the gas source 12 of the service system 10 may be fluidly connected to the flow distribution device 18 by gas line 46. This connection may allow a gas to pass from the gas source 12 to the flow distribution device 18 and into the filter 30. The gas line 46 may be any type of tubing, piping, or hose known in the art. The gas line 46 may be, for example, plastic, rubber, aluminum, copper, steel, or any other material capable of delivering a compressed gas in a controlled manner, and may be flexible or rigid. The length of the gas line 46 may be minimized to facilitate operation of the service system 10, while reducing the pressure drop between the gas source 12 and the filter 30.

The gas source 12 may include, for example, an air compressor, a compressed gas cylinder, and/or any other device capable of compressing a gas and delivering the compressed gas through the gas line 46. For example, in one embodiment of the present disclosure, the gas source 12 may be a shop air compressor of a type known in the art and may supply compressed air at approximately 70 to 110 psi. This range may be increased or decreased depending on the size of the gas source used. In another embodiment of the present disclosure, the gas source 12 may include a gas storage tank (not shown) capable of storing gas at a desired pressure and controllably releasing the stored gas to assist in the removal of matter from the filter 30. It is understood that in a further exemplary embodiment, the engine 22 may be used as a gas source 12 and the gas supplied to the filter 30 may be exhaust gas. The gas source 12 may deliver a gas in either a pulsed flow, a uniform flow, or some combination thereof. The gas may be any gas known in the art useful in removing ash or other matter from a filter, such as, for example, air, oxygen, hydrogen, nitrogen, or helium. It is understood that the gas may be capable of being compressed and delivered through the gas line 46.

The flow distribution device 18 may be rigidly connected to an orifice formed in filter housing 31. Alternatively, the flow distribution device 18 may be removably connectable to the filter housing 31. This connection may be facilitated by a sealable orifice 40. In some embodiments, at least a portion of the flow distribution device 18 may be internal to the filter housing 31. In such an embodiment, the flow distribution device 18 may have unobstructed access to substantially an entire cross-section of the filter media 42 within the filter 30.

As shown in FIG. 1, the sealable orifice 40 may be sized to accept the flow distribution device 18 such that the flow distribution device 18 may be disposed within the filter housing 31 when the service system 10 is connected to the filter 30. The sealable orifice 40 may be located anywhere on the filter housing 31 relative to the filter media 42 and may be, for example, positioned such that the flow distribution device 18 may be positioned downstream of the filter media 42 when inserted through the sealable orifice 40. The sealable orifice 40 may form a substantially air-tight seal with the filter housing 31 when in a closed position. The sealable orifice 40 may include any sealing mechanisms, components, and/or structures known in the art capable of creating such a seal when closed. The sealable orifice 40 may include, for example, dovetails, slots, hinges, clamps, or other moveable mechanisms and may be, for example, a door, a plate, a portion of a cylinder, or any other such structure. It is understood that components of the sealable orifice 40 may be formed of any conventional materials such as, for example, steel, aluminum, or any other metals or alloys. As shown in FIG. 1, the sealable orifice 40 may extend along at least half of the perimeter of the filter 30 and a component of the sealable orifice 40 may be partially or completely removed when the sealable orifice 40 is in an open position. As will be described in further detail below, the filter 30 may include more than one sealable orifice.

The flow distribution device 18 may be any device capable of distributing a compressed gas in a controlled manner. The flow distribution device 18 may be, for example, a perforated disk or cartridge, a nozzle, a diffuser, or any other like device known in the art. The flow distribution device 18 may be made of, for example, plastic, polyvinyl, steel, copper, aluminum, titanium, or any other material known in the art.

The flow distribution device 18 may be, for example, substantially hollow, substantially cylindrical, substantially disk-shaped, and/or any other shape useful in controllably distributing a compressed gas. The flow distribution device 18 may be removably connectable to the filter 30, and at least a portion of the flow distribution device 18 may be disposed within the filter housing 31 when the service system 10 is connected to the filter 30. As stated above, the sealable orifices 40 may be sized and/or otherwise configured to assist in removably connecting the flow distribution device 18 to the filter 30. The flow distribution device 18 may be sized, shaped, and/or otherwise configured to substantially match the dimensions and/or other configurations within the filter housing 31. Accordingly, the flow distribution device 18 may fit tightly within the filter housing 31 when disposed therein. While removably connected to the filter 30, the flow distribution device 18 may be positioned as close to the filter media 42 as is desirable for assisting in matter removal and, as shown in FIG. 1, the flow distribution device 18 may be positioned substantially perpendicular to the filter passages 54 of the filter media 42. It is understood that the flow distribution device 18 may be positioned relative to the filter media 42 to direct a flow across substantially an entire cross-section of the filter media 42. It is further understood that, as shown in FIG. 1, a rear face 45 of the filter media 42 may be substantially an entire cross-section of the filter media 42.

As illustrated in FIG. 3, the flow distribution device 18 may include a surface 48 defining a plurality of holes or orifices 50. In an exemplary embodiment of the present disclosure, at least a portion of the surface 48 may be capable of rotating about a flow distribution device axis (not shown) to assist in maximizing the flow directed into the filter passages 54. The plurality of orifices 50 may be spaced, angled, and/or otherwise positioned on the surface 48 to direct a flow beyond a plurality of blocking apparatuses 52 of the filter 30. The plurality of orifices 50 may also be positioned on the surface 48 to direct a flow across substantially an entire cross-section of the filter media 42. As discussed above, the rear face 45 of the filter media 42 may be substantially an entire cross-section of the filter media 42. In such an exemplary embodiment, the orifices 50 may be positioned and/or otherwise configured to direct the flow through each of the plurality of the filter passages 54 and beyond at least one of the blocking apparatuses 52 of the filter 30.

It is understood that the orifices 50 may be evenly spaced or unevenly spaced and may be at any angle to facilitate the desired distribution of compressed gas across substantially an entire cross-section of the filter media 42. The orifices 50 may be of any shape, size, and/or other configuration known in the art, such as, for example, round, square, or elliptical. Each orifice 50 may be positioned on the surface 48 of the flow distribution device 18 so as to direct a flow through at least one unblocked filter passage 54 when the flow distribution device 18 is connected to the filter 30.

The orifices 50 may also be positioned to create a substantially uniform flow across substantially an entire cross-section of the filter media 42, such as, for example, the rear face 45, when the flow distribution device 18 is positioned at a desired distance from the rear face 45. The flow distribution device 18 may be connected to the filter housing 31 such that the flow distribution device 18 may not be moveable with respect to the filter media 42 once disposed within the filter housing 31 such that this desired distance is maintained. The filter 30 may include, for example, brackets (not shown) or any other structures or devices to assist in maintaining such a relationship between the filter media 42 and the flow distribution device 18. In addition, it is understood that the number of orifices 50 required may depend on, for example, the desired distance between the rear face 45 and the surface 48, the volume of gas supplied by the gas source 12, the pressure required to remove matter from the particular filter 30, and/or the volume of the filter 30 being serviced.

As shown in FIG. 1, the vacuum source 14 of the service system 10 may be connected to the flow receiving device 20 by vacuum line 44. The vacuum source 14 may also include a receptacle 16. It is understood that in an exemplary embodiment, the vacuum source 14 and the vacuum line 44 may be omitted, and the flow receiving device 20 may be directly connected to the receptacle 16.

The flow receiving device 20 may be removably connectable to the filter 30 via a sealable orifice 41. Alternatively, the flow receiving device 20 may be rigidly connected to the filter housing 31. It is understood that the connection between the flow receiving device 20 and the filter 30 may have gaseous and mechanical characteristics similar to the connection between the flow distribution device 18 and the filter 30.

The vacuum source 14 may include, for example, a shop vacuum, a vacuum pump, or any other device capable of creating negative pressure within another device. The vacuum source 14 may be of any power or capacity useful in cleaning the filter 30, and its size may be limited by the size and/or type of filter 30 being cleaned. For example, a filter 30 including cordierite blocking apparatuses 52 may not be capable of withstanding a negative pressure of greater than approximately 1 psi without sustaining damage to the blocking apparatuses 52 and/or other filter media 42. Thus, a vacuum source 14 used to clean such a filter 30 may have a maximum capacity that is less than approximately 1 psi. In some embodiments of the present disclosure, the vacuum source 14 may supply a constant vacuum to, and thereby create a constant negative pressure within, the filter 30. Alternatively, the vacuum source 14 may supply a pulsed or varying vacuum to the filter 30. The consistency of the vacuum supplied to the filter 30 may vary with each application and may depend on the structure, design, type, and/or other characteristics of the filter 30.

As shown in FIG. 1, the vacuum line 44 may connect the vacuum source 14 to the flow receiving device 20. This fluid connection may allow a solid, liquid, or gas to pass from the filter 30 and through the flow receiving device 20. It is understood the fluid connection may permit ash or other matter released from the filter media 42 to pass from the filter 30 to the vacuum source 14 and/or to the receptacle 16. The vacuum line 44 may be any type of vacuum line known in the art and may have mechanical characteristics similar to those of gas line 46. The vacuum line 44 may be as short as possible to facilitate operation of the service system 10 and to reduce the pressure drop between the vacuum source 14 and the filter 30. The vacuum line 44 may be attached to the flow receiving device 20 by any conventional means, such as, for example, adhesives, glue, a compression collar, a ring, matching sets of threads, quick connects, and/or snap fits. It is understood that the vacuum line 44 may be rigid or flexible, and may facilitate movement of at least a portion of the flow receiving device 20 into and/or within the filter housing 31 of the filter 30.

The flow receiving device 20 may be any device capable of delivering a negative pressure in a controlled manner. The flow receiving device 20 may be, for example, a tube, collector, shaft, sheath, disk, or any other like device known in the art. The flow receiving device 20 may be rigid enough to withstand the negative pressure supplied without being more than nominally deformed. The flow receiving device 20 may be composed of, for example, plastic, polyvinyl, steel, copper, aluminum, titanium, or any other material known in the art. The flow receiving device 20 may be, for example, substantially hollow, substantially cylindrical, disk-shaped, and/or any other shape useful in controllably delivering a negative pressure.

As described above with respect to the flow distribution device 18, at least a portion of the flow receiving device 20 may be disposed within the filter housing 31 when the service system 10 is connected to the filter 30. A sealable orifice 41 may be sized and/or otherwise configured to assist in removably connecting the flow receiving device 20 to the filter 30. Sealable orifice 41 may be structurally and/or functionally similar to sealable orifice 40. In an embodiment of the present disclosure, the sealable orifices 40, 41 may be the same. The flow receiving device 20 may be sized, shaped, and/or otherwise configured to substantially match the dimensions and/or other configurations within the filter housing 31. Accordingly, the flow receiving device 20 may fit tightly within the filter housing 31 when disposed therein. The flow receiving device 20 may remain stationary relative to the filter media 42 when the service system 10 is connected to the filter 30.

The flow receiving device 20 may be sized or otherwise configured to deliver an amount of negative pressure useful in assisting in the removal of matter from the filter 30 without causing damage to the filter media 42 or other filter components. In an alternative embodiment, the flow receiving device 20 may be adjustably moveable into and out of the filter housing 31 such that a user may position the flow receiving device 20 as close to the filter media 42 as is desirable for assisting in matter removal. Thus, the flow receiving device 20 may be manipulated or otherwise positioned to maximize the negative pressure delivered across the filter media 42. It is understood that the flow receiving device 20 may be configured to deliver a negative pressure across substantially an entire cross-section of the filter media 42. As shown in FIG. 1, a front face 47 of the filter media 42 may be substantially an entire cross-section of the filter media 42.

As also shown by FIG. 1, the receptacle 16 may be fluidly connected to the vacuum source 14. The receptacle 16 may be configured to collect matter removed from the filter 30 and may be removably attached to the vacuum source 14. For example, in some embodiments, as the vacuum source 14 draws matter from the filter 30, the removed matter may pass through a vacuum filter internal to the vacuum source (not shown). In such embodiments, the receptacle 16 may collect and store the matter collected by the vacuum filter. The receptacle 16 may be any size useful in collecting the matter removed from the filter 30 and may have any useful capacity and shape. For example, the receptacle 16 may be cylindrical or box shaped, and may be a rigid container or a flexible bag. The receptacle 16 may be designed to collect and store matter of any type or composition. In one embodiment of the present disclosure, the receptacle 16 may be designed to store harmful pollutants, such as, for example, ash, and may be made of, for example, steel, tin, reinforced cloth, aluminum, composites, ceramics, or any other material known in the art. The receptacle 16 may be rapidly disconnected and reconnected to the vacuum source 14 to facilitate disposal of the matter collected therein.

Industrial Applicability

The disclosed service system 10 may be used with any filter 30, filtering device, or other matter collection device known in the art. Such devices may be used in any application where the removal of matter is desired. For example, such devices may be used on diesel, gasoline, natural gas, or other combustion engines or furnaces known in the art. These devices may also be used in, for example, coal power plants and/or other types of power plants. Thus, as discussed above, the disclosed service system 10 may be used in conjunction with any work machine, on-road vehicle, off-road vehicle, stationary machine, and/or other exhaust-producing machines to remove matter from a filtering device thereon. The service system 10 may be an on-vehicle or off-vehicle system. In embodiments where the service system 10 is an on-vehicle system, components of the service system 10 may be mounted directly to the work machine and may be removably connectable to the filtering device. For example, the service system 10 could be fixedly secured within a compartment of the work machine, such as the engine compartment. In addition, as discussed above the filter 30 may include additional upstream devices, such as, for example, catalysts and/or work machine diagnostic devices 36, within the filter housing 31. These additional upstream devices may be moved and/or removed to allow access to the filter media 42 for servicing in an on-vehicle system 10.

A variety of different methods and systems may be used to remove matter from the filtering devices of such machines. For example, some filters used in such machines may be cleaned through regeneration. During regeneration, a heater or some other heat source may be used to increase the temperature of the filter components. The heater may increase the temperature of trapped particulate matter above its combustion temperature, thereby burning away the collected particulate matter and regenerating the filter while leaving behind a small amount of ash. Although regeneration may reduce the buildup of particulate matter in the filter, repeated regeneration of the filter may result in a buildup of ash in the components of the filter over time and a corresponding deterioration in filter performance.

Unlike particulate matter, ash cannot be burned away through regeneration. Thus, in some situations, it may be necessary to remove built-up ash from an engine filter using other techniques and systems. The operation of the service system 10 will now be explained in detail.

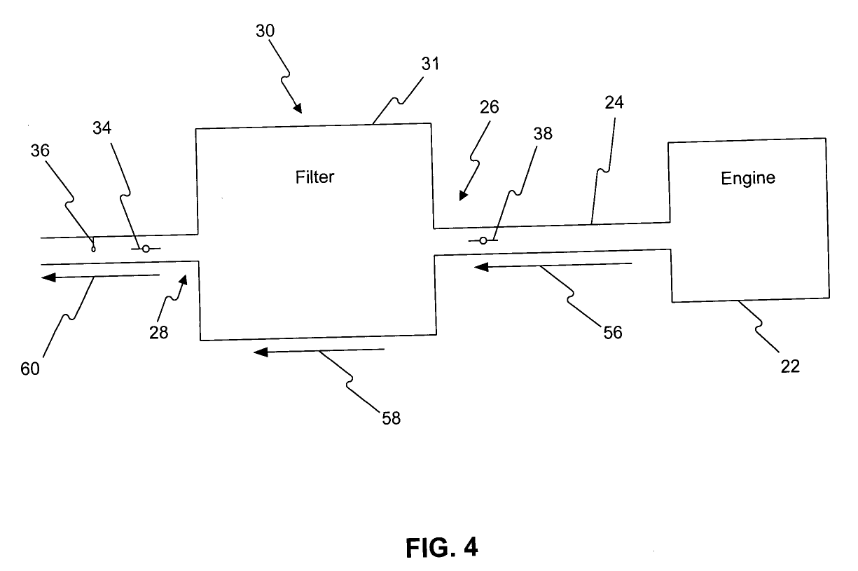

FIG. 4 represents a normal operating condition for the engine 22. In this condition, the service system 10 may not be connected to the filter 30, and the inlet valve 38 and outlet valve 34 may both be open to facilitate passage of an exhaust flow from the engine 22. As illustrated by the exhaust flow arrow 56, the exhaust flow may exit the engine 22 and pass through the exhaust line 24 and open inlet valve 38. The exhaust flow may enter the filter 30 through the inlet 26 and may travel across at least a portion of the filter media 42 (not shown), as illustrated by the process flow arrow 58. Upon exiting the filter 30 via the outlet 28, the exhaust flow may pass through open outlet valve 34 as shown by the filtered flow arrow 60.

Over time, the work machine diagnostic devices 36 may sense an increase in the amount of pollutants being released to the atmosphere. Based on these readings, the filter 30 may undergo regeneration either automatically or as a result of some operator input. As described above, after a number of regeneration cycles, ash may begin to build up in the filter media 42. The service system 10 of the present disclosure may be attached to the filter 30 to assist in removing the ash collected therein. It is understood that the service system 10 may also be used to assist in the removal of soot and/or other matter collected within the filter 30.

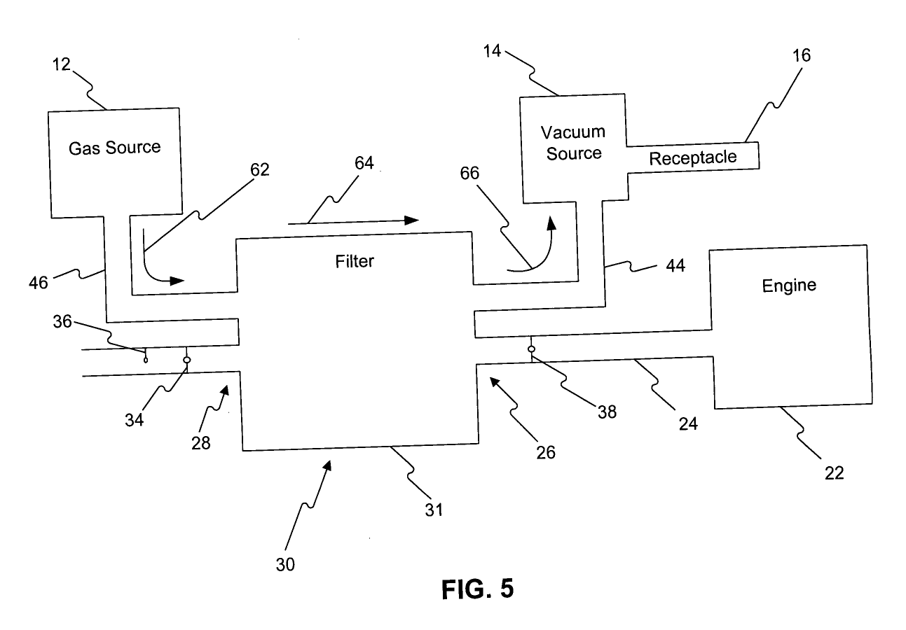

As illustrated by FIG. 5, to begin the removal of ash from the filter 30, the engine 22 may be turned off such that combustion ceases and there is no exhaust flow from the engine 22 to the exhaust line 24. The inlet and outlet valves 38, 34 may be manually closed by the user. Alternatively, in an embodiment where the valves 38, 34 may be actuated by a solenoid or other means (not shown), the valves 38, 34 may be controlled to close remotely. Closing inlet valve 38 may protect components of the engine 22 during the ash removal process and may prevent ash from entering the engine 22 through exhaust line 24. Closing outlet valve 34 while inlet valve 38 is closed may prevent gas from escaping the filter 30 after being supplied by the flow distribution device 18 (not shown).

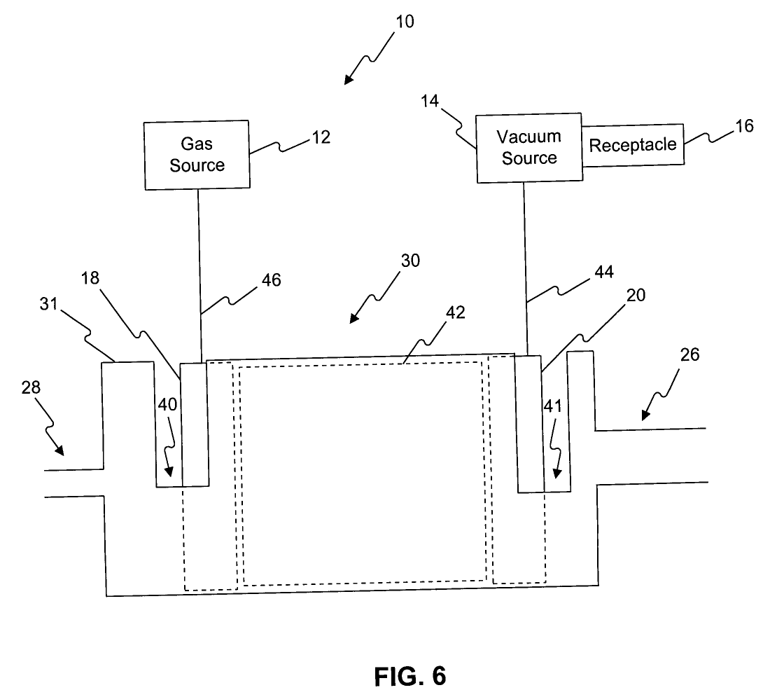

As illustrated in FIG. 6, the gas source 12 may be attached to the filter 30 by opening the sealable orifice 40 and inserting the flow distribution device 18 into the filter housing 31. The flow distribution device 18 may be positioned to direct a flow beyond the blocking apparatuses 52 (see FIG. 1) of the filter 30. The flow distribution device 18 may also be positioned to direct a flow across substantially an entire cross-section of the filter media 42 and through each of the plurality of filter passages 54. As discussed above, the flow distribution device 18 may include a plurality of orifices 50 precisely positioned on a surface 48 of the flow distribution device 18 to assist in directing the flow.

As further illustrated in FIG. 6, the vacuum source 14 may be attached to the filter 30 by opening the sealable orifice 41 on an opposite side of the filter 30 and inserting a flow receiving device 20 into the filter housing 31. The flow receiving device 20 may be inserted into the filter 30 and may be positioned to maximize the amount of vacuum or negative pressure supplied to the filter media 42 without damaging the filter media 42. In an exemplary embodiment, the flow receiving device 20 may be positioned substantially perpendicular to the filter media 42. It is understood that while the flow distribution device 18 and the flow receiving device 20 are removably connected to, and disposed within, the filter 30, the sealable orifices 40, 41 may be open. Matter may not exit the sealable orifices 40, 41 during operation of the service system 10, however, due to the tight fit between the filter housing 31 and the devices 18, 20, respectively. As discussed above, in an exemplary embodiment of the present disclosure, the sealable orifices 40, 41 may be, for example, semi-cylindrical pieces of metal that are clamped, or otherwise secured to the filter 30 in a closed or sealed position. In such an embodiment, a portion of the sealable orifices 40, 41 may be removed in an open position such that the flow distribution device 18 and the flow receiving device 20 may be inserted into the filter housing 31. FIG. 6 illustrates this exemplary embodiment and shows the sealable orifices 40, 41 in an open position in which a portion of the orifice structure has been removed. It is understood that in an additional exemplary embodiment, at least a portion of the sealable orifices 40, 41 may remain connected to the filter 31 in an open position.

The gas source 12 may be activated and may begin to supply compressed gas to the filter 30, as shown by compressed flow arrow 62. As discussed above, in an embodiment of the present disclosure, the compressed gas may be, for example, air. Although this flow is shown schematically in FIG. 5, it is understood that compressed air may be supplied by the flow distribution device 18 to obtain maximum air distribution across the filter media 42. This distribution of compressed air may be the result of the design of the flow distribution device 18, such as, for example, the location of the orifices 50 on surface 48. The orifices 50 may assist in, for example, directing the flow of compressed air beyond the blocking apparatuses 52 of the filter 30. It is understood that while compressed air is being supplied by the gas source 12, the position, location, and/or orientation of the flow distribution device 18 relative to the filter media 42 may remain substantially constant.

The vacuum source 14 may be activated at substantially the same time as the gas source 12 and may supply a vacuum or negative pressure to the filter 30 while the gas source 12 supplies compressed air. The gas source 12 and the vacuum source 14 may force air through the filter 30 in a direction opposite the direction of exhaust flow during normal filter operating conditions (FIG. 5). The combination of compressed air and vacuum may improve the ash removal capabilities of the service system 10 and may be useful in removing ash lodged deep within the filter media 42 of the filter 30. This air flow is illustrated by reverse flow arrow 64 in FIG. 5.

In some embodiments, the volume of compressed air supplied by the gas source 12 may substantially coincide with the volume of gas removed by the vacuum source 14. In other embodiments, however, the output of the gas source 12 may not be related to the input of the vacuum source 14. It is understood that in embodiments where the input of the vacuum source 14 and the output of the gas source 12 are not calibrated to be substantially equivalent, the overall efficiency of the service system 10 may not be maximized.

Once ash is broken free, it may be carried into the vacuum source 14 as shown by vacuum flow arrow 66 and/or into the receptacle 16. The ash may be safely stored in the receptacle 16 throughout the ash removal process and may reside in the receptacle 16 until disposed of.

The user may determine whether the filter 30 is substantially free of ash by using existing work machine diagnostic devices 36, or other means known in the art. For example, after forcing a reversed flow of compressed air through the filter 30, the user may disconnect the service system 10, open the inlet and outlet valves 38, 34, and start the engine 22. Work machine diagnostic devices 36 downstream of the filter 30 may determine whether the filter 30 is operating under substantially ash-free conditions or whether the filter 30 requires further service.

Other embodiments of the disclosed service system 10 will be apparent to those skilled in the art from consideration of the specification. For example, the inlet and outlet valves 38, 34 may be three-way valves and may be capable of directing an exhaust flow of the engine 22 in an alternate path while the filter 30 is being serviced. In addition, the filter 30 may be fitted with more than two sealable orifices 40, 41 to provide access to the filter media 42 and facilitate insertion of alternative matter removal devices. Furthermore, the gas source 12 and the vacuum source 14 may be the same device.

In addition, the service system 10 may include at least one sensor for sensing a characteristic of a flow through the filter 30. The sensor may be connected to a service system controller. The controller may control aspects of the ash removal process in response to signals received from the at least one sensor. To facilitate this control, the inlet and outlet valves 38, 34, the gas source 12, and/or the vacuum source 14 may be controllably connected to the controller. It is intended that the specification and examples be considered as exemplary only, with the true scope of the invention being indicated by the following claims.

What is claimed is:

1. A system for removing matter from a filtering device, comprising:
a gas pressurization assembly, an element of the gas pressurization assembly being removably connectable to the filtering device and having a surface defining a plurality of orifices, the plurality of orifices being positioned on the surface to direct a flow beyond at least one blocking apparatus of the filtering device; and
a matter collection assembly removably connectable to the filtering device.

2. The system of claim 1, wherein the system is removably connected to the filtering device and is configured to remove matter from the filtering device while the filtering device is connected to a work machine.

3. The system of claim 1, wherein the gas pressurization assembly includes a flow distribution device fluidly connected to a gas source, the flow distribution device being removably connectable to the filtering device.

4. The system of claim 3, wherein the flow distribution device is disposed within the filtering device and the plurality of orifices are positioned to direct the flow through a plurality of filter passages.

5. The system of claim 4, wherein the plurality of filter passages are defined by a filter media within the filtering device.

6. The system of claim 3, wherein the gas source includes a compressor.

7. The system of claim 1, wherein the at least one blocking apparatus of the filtering device includes a plurality of plugs.

8. The system of claim 1, wherein the filtering device further includes a first sealable orifice configured to assist in removably connecting the element of the gas pressurization assembly to the filtering device.

9. The system of claim 1, wherein the matter collection assembly includes a flow receiving device fluidly connected to a vacuum source, the flow receiving device being removably connectable to the filtering device.

10. The system of claim 9, wherein the filtering device further includes a second sealable orifice configured to assist in removably connecting the flow receiving device to the filtering device.

11. The system of claim 9, wherein the flow receiving device is disposed within the filtering device and is configured to accept a flow from a plurality of filter passages.

12. The system of claim 9, further including a receptacle fluidly connected to the vacuum source for collecting at least a portion of the matter removed by the system.

13. The system of claim 9, wherein the vacuum source includes a vacuum pump.

14. The system of claim 1, wherein the matter collection assembly includes a receptacle fluidly connected to the filtering device for collecting at least a portion of the matter removed by the system.

15. The system of claim 1, wherein the filtering device is a particulate filter.

16. A system for removing matter from a filtering device, comprising:
a gas pressurization assembly, an element of the gas pressurization assembly including a surface defining a plurality of orifices, the plurality of orifices being positioned on the surface to direct a flow across substantially an entire cross-section of a filter media of the filtering device when the gas pressurization assembly is connected to the filtering device; and
a matter collection assembly removably connectable to the filtering device.

17. The system of claim 16, wherein the system is removably connected to the filtering device and is configured to remove matter from the filtering device while the filtering device is connected to a work machine.

18. The system of claim 16, wherein the cross-section of the filter media is a rear face of the filter media.

19. The system of claim 16, wherein the element of the gas pressurization assembly is a flow distribution device fluidly connected to a gas source, the flow distribution device being removably connectable to the filtering device.

20. The system of claim 19, wherein the flow distribution device is disposed within the filtering device when the gas pressurization assembly is connected to the filtering device.

21. The system of claim 19, wherein the filtering device further includes a first sealable orifice configured to assist in removably connecting the flow distribution device to the filtering device.

22. The system of claim 16, wherein the plurality of orifices are positioned to direct a flow through a plurality of filter passages when the gas pressurization assembly is connected to the filtering device.

23. The system of claim 22, wherein the plurality of filter passages are defined by the filter media of the filtering device.

24. The system of claim 16, wherein the vacuum assembly includes a flow receiving device fluidly connected to a vacuum source, the flow receiving device being removably connectable to the filtering device.

25. A method of removing matter from a filtering device, comprising:
connecting a gas pressurization assembly to the filtering device;
connecting a matter collection assembly to the filtering device; and
directing a flow of compressed gas across substantially an entire cross-section of a filter media of the filtering device.

26. The method of claim 25, further including supplying a negative pressure to at least a portion of the filtering device with the matter collection assembly.

27. The method of claim 25, further including directing the flow of compressed gas across at least a portion of the filtering device in a direction opposite from the direction of normal flow through the filtering device.

28. The method of claim 25, wherein the element of the gas pressurization assembly is a flow distribution device removably connectable to the filtering device.

29. The method of claim 25, wherein the system is removably connected to the filtering device and is configured to remove matter from the filtering device while the filtering device is connected to a work machine.

30. The method of claim 25, wherein connecting the gas pressurization assembly to the filtering device includes disposing the element of the gas pressurization assembly within the filtering device.

31. The method of claim 25, further including directing the flow of compressed gas beyond at least one blocking apparatus of the filtering device.

32. The method of claim 25, further including directing the flow of compressed gas through a plurality of filter passages defined by the filter media.

33. The method of claim 25, wherein the cross-section of the filter media is a rear face of the filter media.
